(19) United States
(12) Patent Application Publication
(10) Pub. No.: US 2020/0154677 A1
(43) Pub. Date: May 21, 2020

(54) PALM ACTIVATED RETRACTABLE LEASH

(71) Applicant: Bow and Arrow Marketing, Inc., Eden Prairie, MN (US)

(72) Inventor: John Anderson, Hopkins, MN (US)

(73) Assignee: Bow and Arrow Marketing, Inc., Eden Prairie, MN (US)

(21) Appl. No.: 16/688,771

(22) Filed: Nov. 19, 2019

Related U.S. Application Data
(60) Provisional application No. 62/769,257, filed on Nov. 19, 2018.

(51) Int. Cl. A01K 27/00; B65H 75/44

(52) U.S. Cl. CPC A01K 27/004; B65H 2701/35; B65H 75/4431

(57) ABSTRACT

A palm operable leash and operation of a palm activated leash is disclosed. In one or more examples, the leash is a retractable leash. The leash operation is palm activated. In one example, a palm operable actuator is located in the palm area of a retractable leash handle, and is used to lock and unlock the leash.

### CROSS-REFERENCE TO RELATED APPLICATION

This application is a Non-Provisional of U.S. application Ser. No. 62/769,257, filed Nov. 19, 2018, which is herein incorporated by reference.

### BACKGROUND

Retractable leashes are popular for use in walking pets, namely dogs. Known retractable leashes can extend up to 10, 15 or even 20 feet. These leashes are desirable for allowing dogs more freedom to explore when out on a walk.

A typical retractable leash includes a length of cord or tape spooled on a spring loaded retractable reel positioned within a housing. The housing may also include a rigid plastic handle as part of the housing. A thumb operated pushbutton that extends through the top of the housing controls how much the leash is extended. In operation, the leash extends as the dog pulls on the leash. The pushbutton is operated to either stop extending the leash and/or locking the leash at a desired length. Such pushbutton mechanisms can result in a “hard” stop of the dog. A leash “hard” stop of a running dog can cause injury to a dog, dog owner, or both. Further, depending on the type of dog, and how aggressive the dog is, pushbutton operation of a retractable leash may not be desirable.

It is further sometimes difficult to both hold onto a leash to restrain an animal, and operate the leash using a thumb button. For example, in colder climates it may be undesirable to operate a leash using a thumb button while wearing large gloves or mittens.

For these and other reasons, there is a need for the present invention.

### SUMMARY

The above mentioned problems of retractable leashes are addressed by embodiments of the present invention and will be understood by reading and studying the following specification. The following summary is made by way of example and not by way of limitation. It is merely provided to aid the reader in understanding some of the aspects of the invention.

One or more embodiments of the present invention provide a palm operable retractable leash. The palm operable leash may be used to control the amount of leash extended, and/or used as a leash braking mechanism to avoid “hard” stops of the leash.

One or more embodiments and other examples are described in broad terms in the below paragraphs. Further aspects will become apparent from consideration of the drawings and the description of embodiments of the invention. The present disclosure is an exemplification of the principles of the invention and is not intended to limit the invention to the particular embodiments illustrated or described. A person skilled in the art will realize that other embodiments of the invention are possible and that the details of the invention can be modified in a number of respects, all without departing from the inventive concept. This, the drawings and description are to be regarded as illustrative in nature and not restrictive.

### BRIEF DESCRIPTION OF THE DRAWINGS

FIG. 1 illustrate one or more examples of a palm operable leash assembly and method of operating a palm operable leash assembly.

FIG. 2 is an operational diagram illustrating one example of a leash assembly system.

FIG. 3 illustrates one example of a palm operable leash assembly.

FIG. 4 is an exploded view illustrating on example of a palm operable leash assembly.

FIG. 5 illustrates one example of a portion of a palm operable leash assembly.

FIG. 6 illustrates one example of a portion of a palm operable leash assembly.

FIGS. 7a and 7b illustrate one example of a portion of a palm operable leash assembly.

FIG. 8 illustrates a close up view of one example of a portion of a palm operable leash assembly.

FIG. 9 illustrates a close up view of one example of a portion of a palm operable leash assembly.

FIG. 10 illustrates a close up view of one example of a portion of a palm operable leash assembly.

FIG. 11 illustrates another example of a palm operable leash assembly and method of operating a palm activated leash.

FIG. 12 illustrates another example of a palm operable leash assembly and method of operating a palm activated leash.

FIG. 13 illustrates another example of a palm operable leash assembly and method of operating a palm activated leash.

FIG. 14 illustrates another example of a palm operable leash assembly and method of operating a palm activated leash.

FIG. 15 illustrates another example of a palm operable leash assembly and method of operating a palm activated leash.

FIG. 16 illustrates another example of a palm operable leash assembly and method of operating a palm activated leash.

FIG. 17 illustrates one example of a gear assembly and operation of a gear assembly for use with a palm operable leash assembly.

FIG. 18 illustrates one example of modes of operation of a palm operable leash assembly.

FIG. 19 illustrates another example of a palm operable leash assembly.

### DETAILED DESCRIPTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

A palm operable leash and operation of a palm operable leash is disclosed. In one or more examples, the leash is a retractable leash. The leash operation can be palm activated. In one example, the handle is used to lock and unlock the leash. In another example, the handle is used to operate a braking mechanism, where the amount of braking is proportional to the amount the handle is squeezed. In other examples, the palm activated handle is used to brake and stop the leash, in combination with a pushbutton that is used to lock and unlock the leash.

In one example, the present application discloses a leash assembly that includes a housing having a housing body and a handle having a palm region. A leash is spooled within the housing body. An actuator is located in the palm region of the handle, where activation of the actuator within the palm region operates the leash to control an amount of leash extended from the housing.

In another example, the present application discloses a retractable leash assembly. The retractable leash assembly includes a housing including a housing body and a handle. A wheel drum is located within the housing body, where a leash spools within the housing body about the wheel drum, the handle operably connected to the wheel drum. The handle includes an palm region located about an outer edge of the handle, and where activation of the handle within the palm region aids in controlling the amount of leash extended from the housing.

In another example, the present application discloses a retractable leash system. The retractable leash system includes a leash body and a handle, the handle having a palm region. A wheel drum located within the leash body, including where the leash spools within the leash body about the wheel drum, the handle operably connected to the wheel drum. A leash actuator is located within the palm region. A gear assembly is operably positioned between the leash actuator and the wheel drum, where activation of the leash actuator operates to move the leash between one or more modes of operation via the gear assembly.

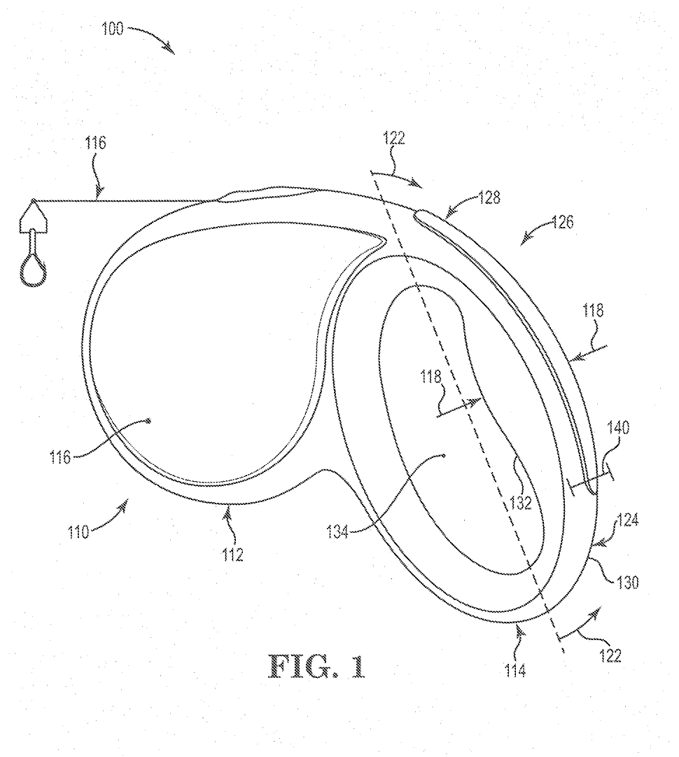

FIGS. 1-23 illustrate one or more examples of a palm operable leash assembly and method of operating a palm operable leash assembly.

FIG. 1 illustrates one example of a retractable leash assembly generally at 100. The leash assembly 100 includes a housing 110, having a housing body 112 and a handle 114. A spooled leash 116 is located in the housing body 112. The leash 116 is operably controlled by activation of the handle. In one example, the leash is activated by squeezing or compressing the handle, indicated at 118. In one example, a wheel drum assembly 120 is located within the housing body 112. In one aspect, the wheel drum 120 is a retractable drum (e.g. a spring loaded drum). Leash 116 is spooled within the housing body 112 about the wheel drum assembly 120. The handle 114 is operably connected to the wheel drum assembly 120. The handle 114 includes a palm region 122 located about an outer edge 124 of the handle 114, where activation of the handle 114 within the palm region 122 aids in controlling the amount of leash 116 extended from the housing 110.

As used herein, the term palm region is defined as an area on the leash handle where a user's palm typically comes in contact with the leash during holding of the leash or operation of the leash. In one example, it is a middle region along an outside edge of the handle.

In one example, the leash 100 includes an actuator 126. For one example, actuator 126 is in the form of a pushbutton 128. In other examples, the actuator 126 may be located inside handle 114 and handle 114 itself may be squeezed or compressed within the palm region 122 to operate or aid in operating the leash assembly 110. In yet other examples, actuator 126 may be in the form of a pushbutton located on the inside of the leash handle within the palm region 122 to aid in operating the leash assembly 100.

In FIG. 1, the leash 116 is shown extending from the housing body. In other drawing figures illustrated herein, the leash is not shown on the spool inside the housing for ease of illustrating a retractable leash assembly or system and operation of the leash assembly.

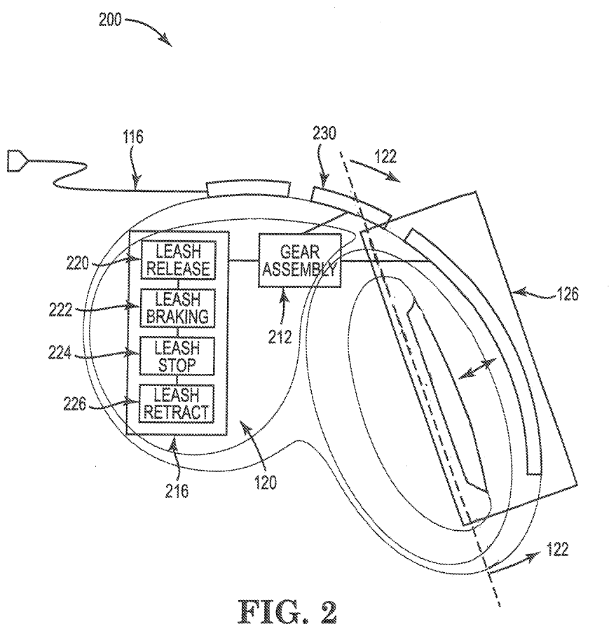

FIG. 2 illustrates is an operational system diagram illustrating one example of a leash system. Leash system 200 shown in operational view is an operational diagram of leash assemblies described herein, including leash assembly 100. For discussion purposes, reference is also made to FIG. 1 for discussing the operation of the leash system 200. Leash system 200 includes leash actuator 126, gear assembly 212, and wheel drum assembly 120. In operation, leash actuator 126 aids in operating wheel drum assembly 120 to move between one or more leash modes of operation 216. In one example, leash system 200 utilizes a key system, track system or gear assembly 212 to aid in operating leash system 200 to move between one or more leash modes of operation 216.

Leash actuator 126 is located within the palm region 124 of a retractable leash assembly 100. As such, user is able to operate the leash assembly 100 including moving the leash assembly 100 between different modes of operation 216 by holding, compressing or squeezing the leash housing within the palm region 124. This is very advantageous to a leash assembly user. As such, an additional external pushbutton located on top of the leash housing 110 is not necessary. Such a pushbutton is typically operated by user using their thumb. At times thumb operation becomes difficult due to the strain put on the leash by the leashed animal, or due to other external reasons such as a user wearing gloves or mittens. In other examples, leash actuator 126 is located within the palm region 124 and is utilized for one or more first modes of operation, such as a leash breaking or leash stopping mode of operation. A second mode of operation, such as leash locking and unlocking, could be accomplished using a separate pushbutton 230 located near the top of the housing 110.

In one example, leash actuator 126 is a compressible button that extends through an opening in the housing such as is illustrated in FIG. 1. In one example, the leash handle 114 includes an exterior surface 130 and an interior surface 132, including a central opening 134 for extending a user hand therethrough that defines the interior surface 132. In one example, the actuator 126 is positioned at the exterior surface 130 in the palm region 122. In another example, the actuator 126 is located at the interior surface 132 in the palm region 122. In one another example, the actuator 126 is positioned internally within the handle 114, at least partially within the palm region 122.

In one example, the leash actuator 126 is in the form of a spring loaded, pressable button that extends longitudinally along a length of the palm region 122, on the exterior surface 130 or the interior surface 132. The button may or may not extend above the exterior surface of the housing. See, for example, pushbutton 128 in FIG. 1.

In one example, the button 128 has a compressible length of travel 140 where the length of travel 140 is used in operation of the button 128. For example, in one operation activation of the button 128 causes a braking mode of the leash assembly. In one aspect, an amount of breaking of the leash is proportional to the amount the compressible button 128 is compressed along the compressible length of travel 140. In another example, when button 128 is compressed along the first 60% of the length of the travel, the leash is in a breaking mode of operation. When button 128 is compressed along the final 40% of the length of travel, the leash is in a stop mode of operation.

Gear assembly 212 operates to aid in moving the leash system 200 between one or more leash modes of operation 216. In one example, gear assembly 212 includes a key or slot system operably positioned between the leash actuator 126 and wheel assembly 120. The gear assembly 212 is operably coupled to the leash actuator 126 to move the leash system between a leash release mode 220, a leash braking mode 222, a leash stop mode 224, and a leash retract mode 226. One or more examples of the gear assembly 126, wheel drum assembly 120, and leash modes of operation 216 are discussed in this specification.

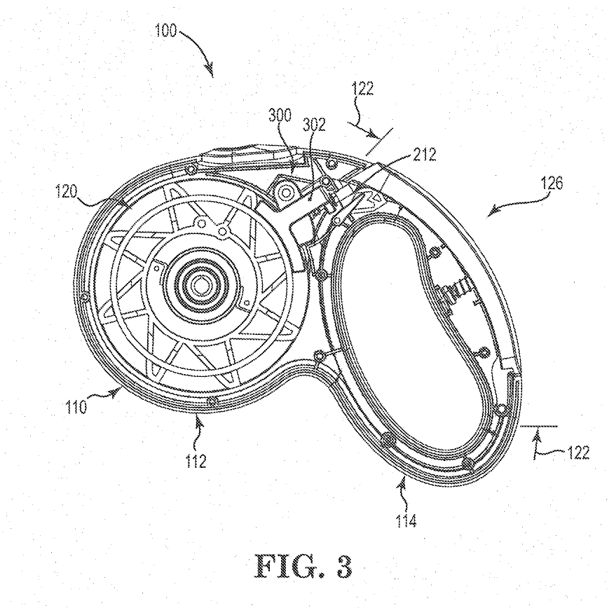

FIG. 3 illustrates one example of a palm operable leash assembly 100. Leash assembly 100 is illustrated with part of the housing 110 removed. As illustrated, wheel drum assembly 120 is positioned within the body 112 of housing 110. Leash actuator 126 is positioned within the palm region 122 of handle 114. Further illustrated is a stop or lock assembly 300 and a break mechanism 302 operably positioned between gear assembly 212 and wheel drum assembly 120.

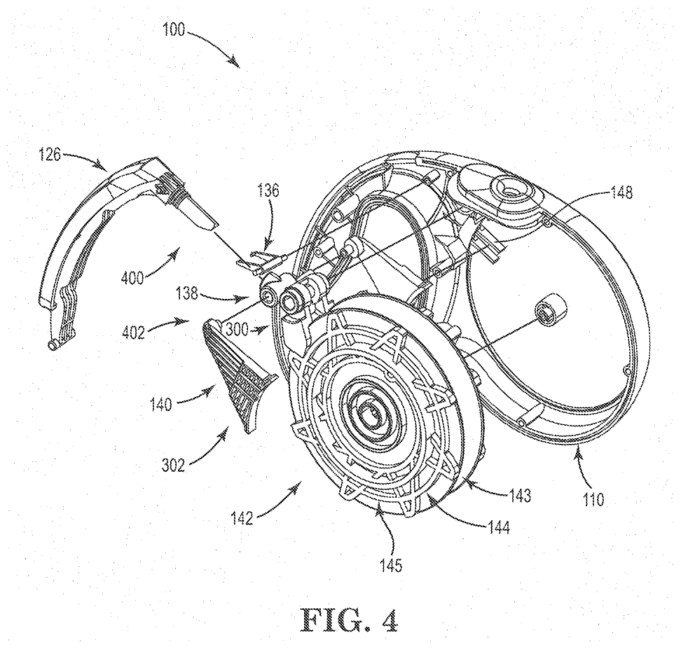

FIG. 4 is an exploded view illustrating one example of a palm operable leash assembly 100. The assembly 100 includes actuator 126, locking pin arm 136, brake/actuator connector 138, brake arm 140, wheel assembly 120 having wheel 142 and drum 144, and locking member 146. In assembly, at 400 actuator 126 (in the form of a handle) slides through brake/actuator connector 138 to reach a lock 146. At 402, the locking pin arm 136 has an axle and a slot on the housing to pivot on while the pin arms grab and ride in the groove of the actuator 126. At 404, brake mechanism 302 fits into the brake/actuator connector 138 without interfering with the actuator 126 handle. Brake 140 grooves slide on the bars 148 on the inside of the housing 110. Brake 140 grooves mate with grooves or bars 148 on the inside wall of the housing 110.

Wheel assembly 120 includes a wheel 142 having a leash spool area 143, a wheel lock area 149, and a wheel drum area 145. In operation, the retractable leash spools and unspools about wheel spool area 143. In a leash locking mode, wheel lock area 144 provides a locking surface for stop or lock assembly 300 including brake arms 140. Wheel drum area 145 provides a braking surface for break mechanism 302. In operation, brake mechanism 302 rubs on the wheel drum area 145 to provide breaking of the leash. In one example illustrated, the wheel spool area 143 is centered on wheel 142, wheel lock area 144 is located immediately adjacent wheel spool area 142, and wheel drum area 145 is located immediately adjacent the wheel lock area 144. It is recognized that other useful configurations for wheel 142 may also be used.

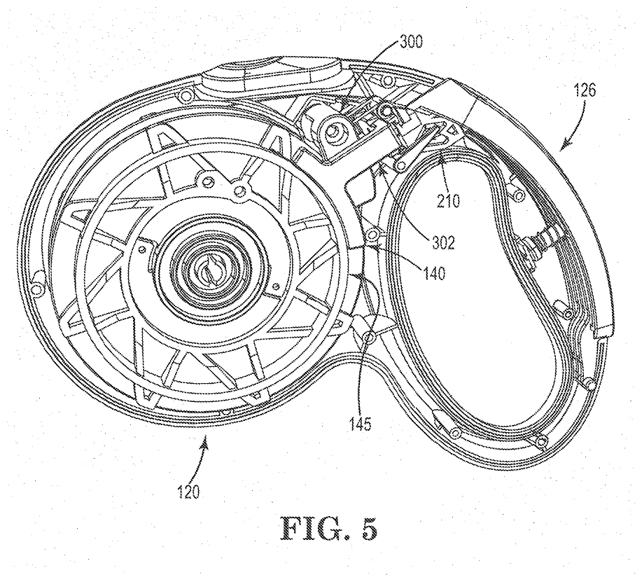

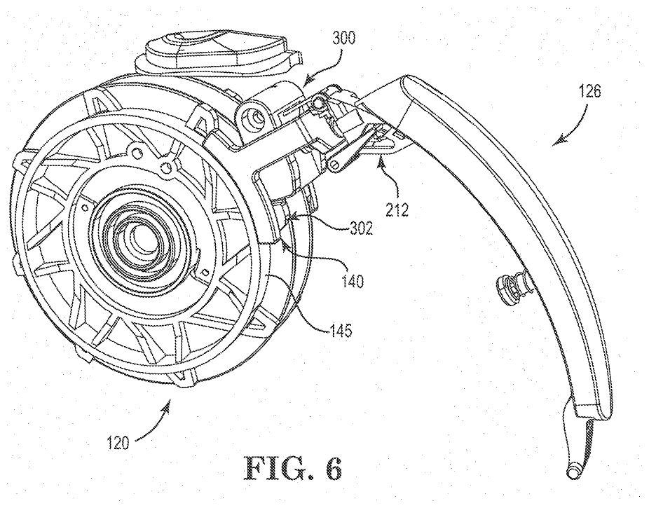

FIG. 5 illustrates one example of a portion of a palm operable leash assembly. Actuator 126 is operably coupled to lock assembly 300 and break mechanism 302 via gear assembly 210. As illustrated, break mechanism 302 is operably coupled in a breaking mode, as illustrated by brake arm 140 positioned against the wheel drum area 145 of wheel 120. FIG. 6 illustrates one example of a portion of a palm operable leash assembly as illustrated in FIG. 5 with the housing removed.

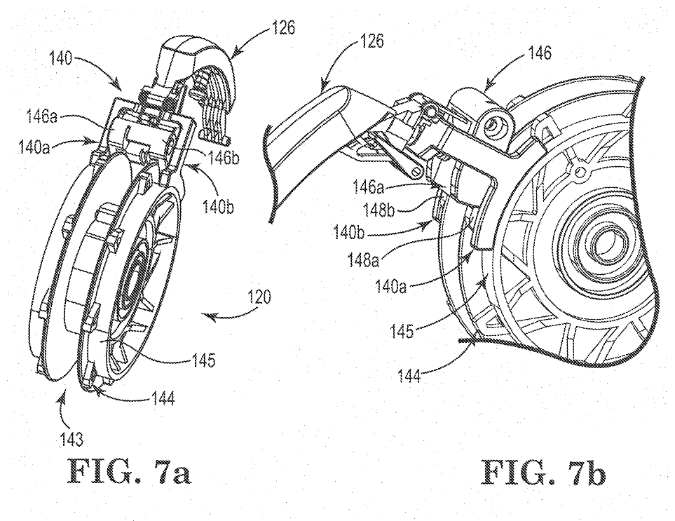

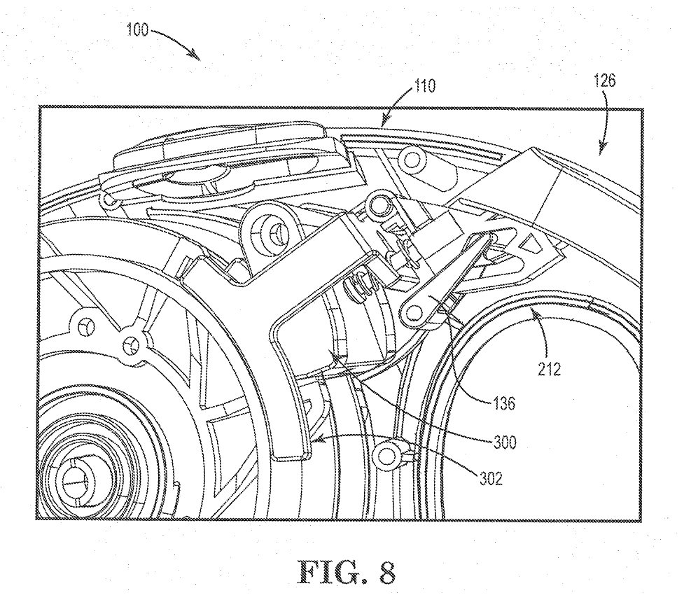

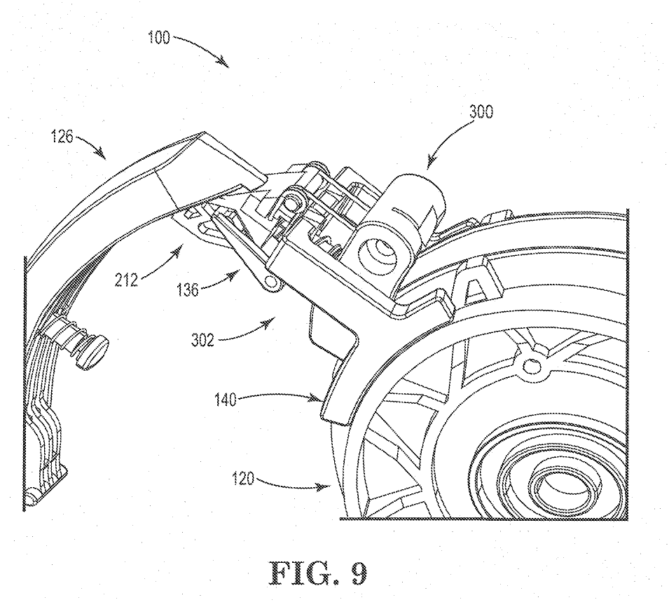

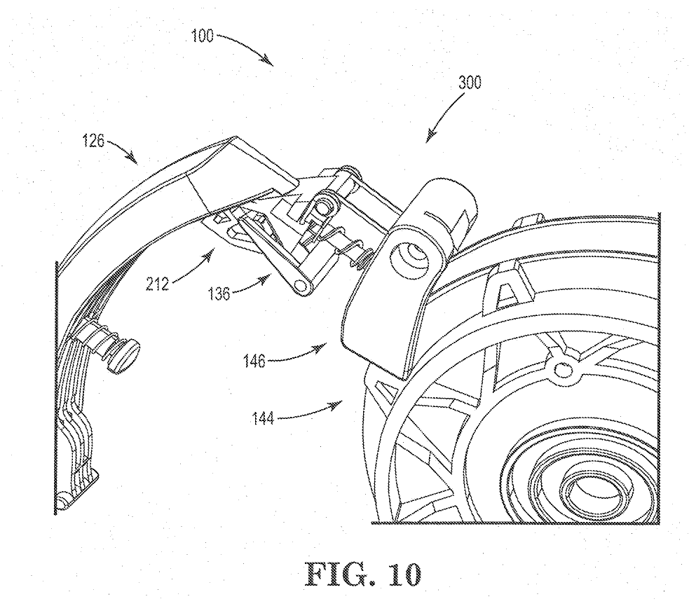

In a similar manner, FIGS. 7a-10 illustrate various close-up views of one example of one or more portions of a palm operable leash assembly. At FIG. 7a and FIG. 7b an enlarged end view of retractable leash assembly 100 is shown. This view illustrates one configuration of wheel 120, including wheel spool area 143, wheel lock area 144 and wheel drum area 145. Brake arm 140 is generally U-shaped, and includes a first brake arm 140a and a second brake arm 140b. In operation, the first brake arm 140a and second brake arm 140b both press against corresponding wheel drum areas 145a and 145b. This provides dual breaking arms against dual breaking surfaces. In a similar manner, lock assembly 300 includes lock arms 146a and lock arms 146b which operate with corresponding drum lock areas 148a and 148b. FIGS. 8 and 9 are close-up views of lock assembly 300 in a locking mode and brake mechanism 302 in a braking mode. FIG. 10 is a close-up view illustrating brake mechanism 302 in a braking mode without the lock assembly shown.

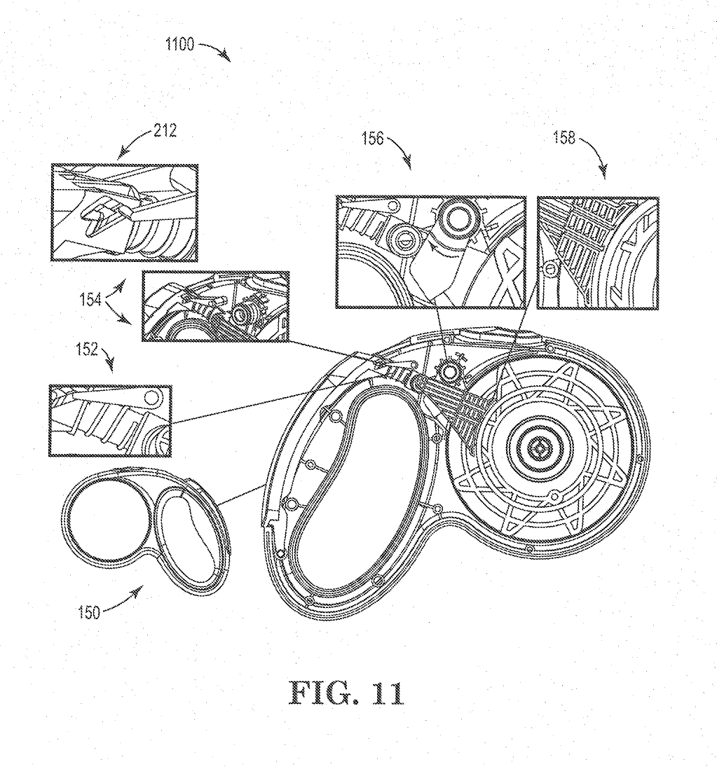

FIGS. 11-16 illustrates one example of varying modes of operation of leash assembly 100. Elements not identified in FIGS. 11-16 are identified in previously discussed Figures.

FIG. 11 illustrates a leash release mode at 1100, showing letting out or retracting of the leash from the leash assembly 100. Gear assembly 212 having groove 500 is illustrated. At 150, the actuator is far away from the housing so that it has room to be pressed inward. At 152, the spring is uncompressed. At 154, locking pin arm 502 is fixed inside the gear assembly 212 grooved path to the farthest forward position. At 156, the lock is pushing against the actuator in a counterclockwise direction. At 158, there is room between the brake and the wheel drum.

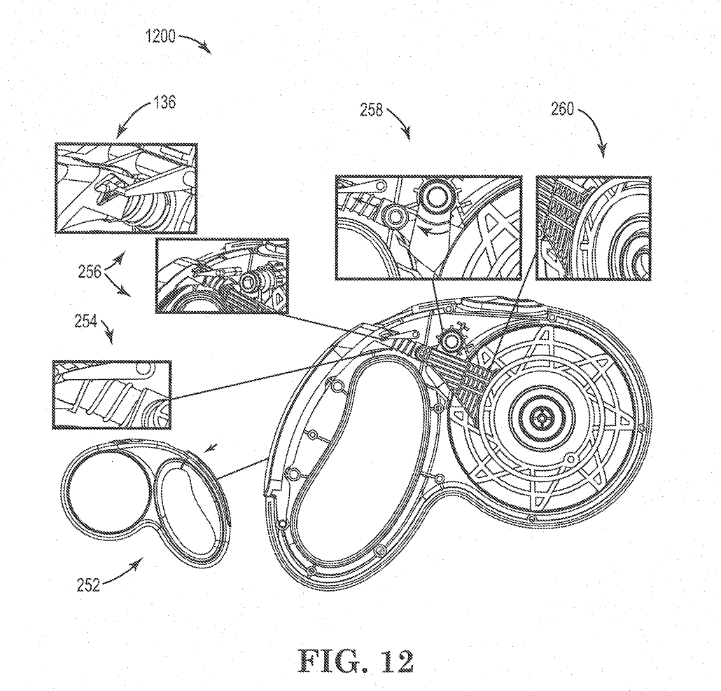

FIG. 12 illustrates a leash assembly braking mode at 1200. At 252, the actuator is pressed forward and shown midway through its travel toward the leash housing. At 254, the spring is slightly compressed. At 256, the locking pin arm 136 is moving backward in the track of gear assembly 212. At 258, the lock is pushing the actuator while the spring is being compressed due to the brake being engaged. At 260, the brake is being pressed against the wheel drum, providing a braking operation to the leash.

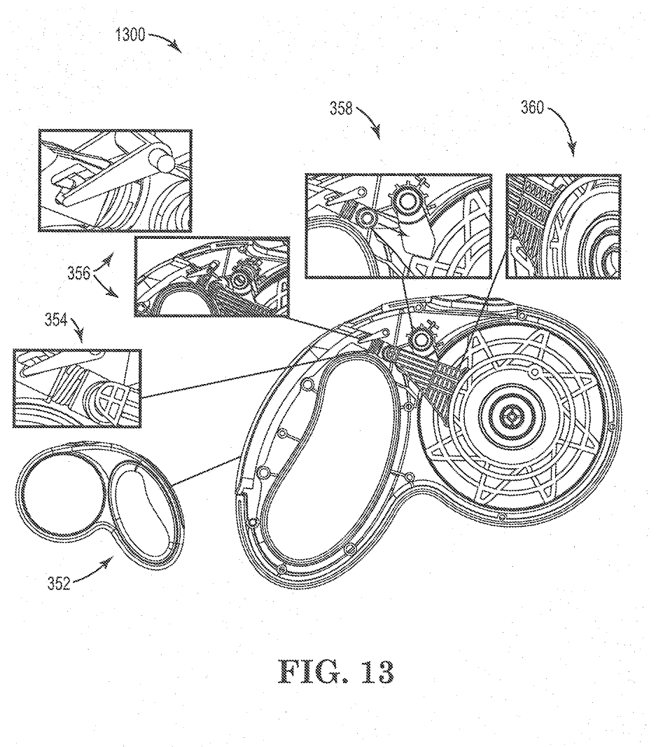

FIG. 13 illustrates a leash assembly stopping mode or engaging the lock mechanism mode at 1300. At 352, the actuator is all the way pressed down toward the housing. At 354, the spring is completely compressed. At 356, the locking pin arm is all the way pressed backward. At 358, the lock is pushed by the actuator forward into the teeth of the wheel. At 360, the brake is still being pressed against the wheel drum.

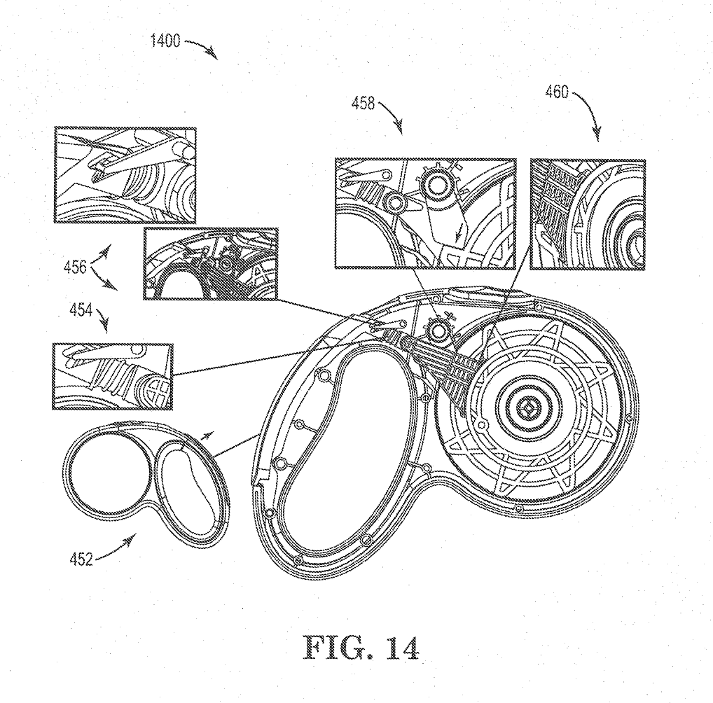

FIG. 14 illustrates a leash assembly leash locked in place mode at 1400. At 452, the actuator handle is released a little farther out from the housing. At 454, the spring is mostly compressed. At 456, the locking pin arm is locked in place towards the back of the track. At 458, the lock is engaged with the wheel and there is some room between the lock and the actuator. At 460, the brake is still being pressed against the wheel drum.

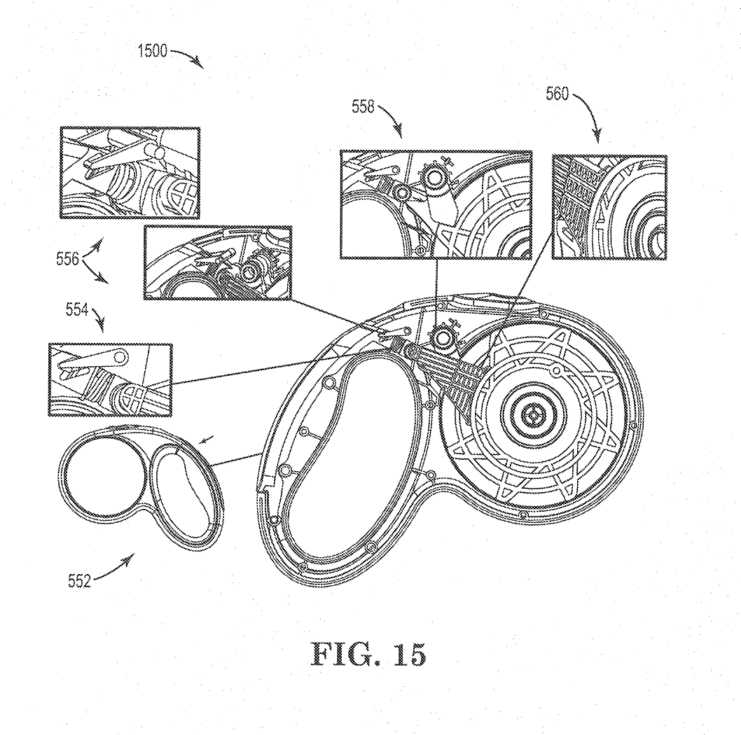

FIG. 15 illustrates a leash assembly mode of disengaging the lock at 1500. At 552, the actuator handle is pressed all the way down. At 554, the spring is completely compressed. At 556, the locking pin arm is moved backwards on the track. At 558, the actuator comes in contact with the lock again at the most forward position. At 560, the brake is still being pressed against the wheel.

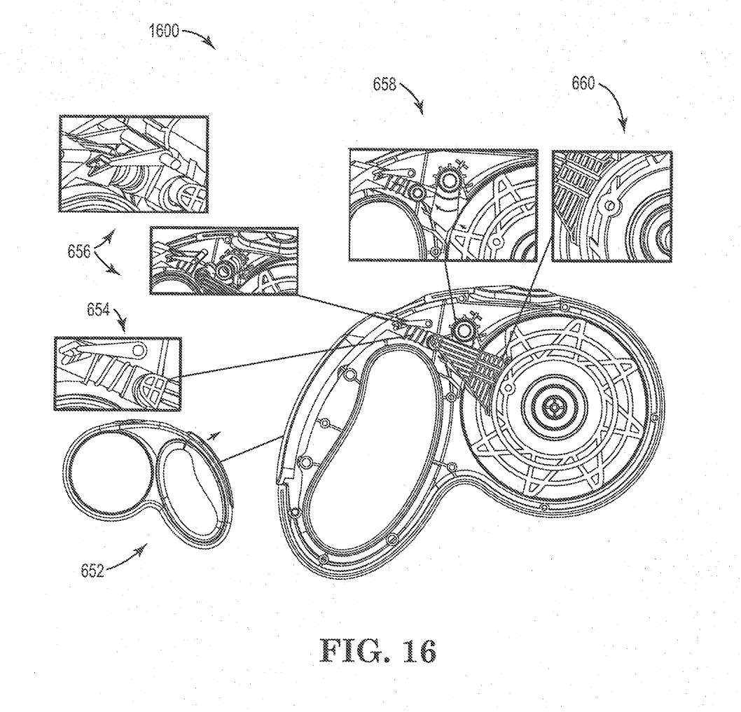

FIG. 16 illustrates a leash release mode at 1600, where the leash returns to a position where a user can retract the leash and/or let out the leash. At 652, the actuator is moving back to be far from the housing to the original position. At 654, the spring is returning to be decompressed. At 656, the locking pin arm is moving forward towards the original starting position. At 658, the lock is disengaging with the wheel and rotating clockwise, pushing the actuator back. At 660, the brake is being released from the wheel drum.

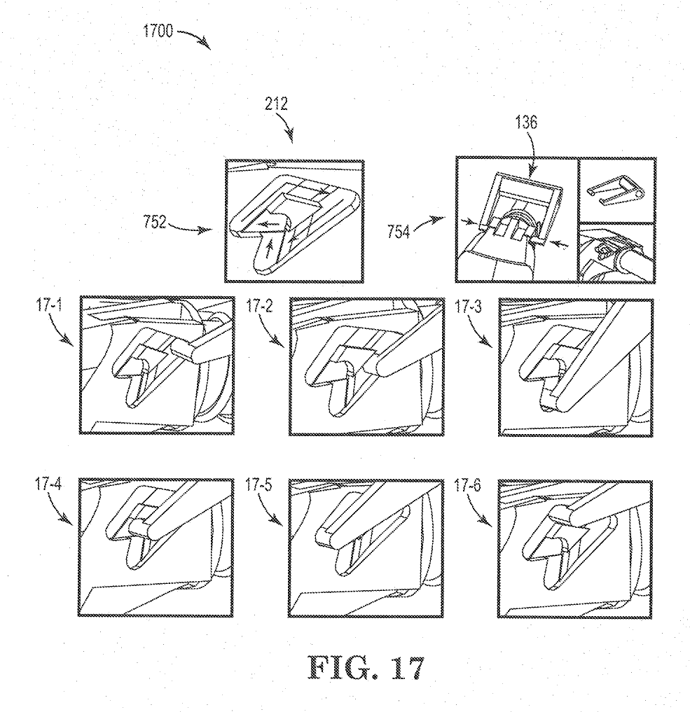

FIG. 17 is a series of diagrams that illustrate at 1700 one example of operation of the gear assembly 212, the gear assembly 212 including a track 752 for the pin arms 136 to move when operation of the actuator moves the leash assembly between modes. The track 752 defines areas where the pin arms 136 can move. The pin arms 136 can only move in a clockwise direction due to each area (indicated by directional arrows) having different surface levels. As such, once on a deeper or advanced level, it can't move back. The pin arms 136 will make a “click” sound when falling into the next or deeper level.

The pin arms provide a notifying “click” at each level drop. With the pin arms, pressure is creating an inward force because the distance between the pin arms is smaller than the distance between the track groove on each side of the actuator, indicated at 754.

A sequence of operation through the gear assembly tracks is next illustrated. At 17-1, the pins arms are in a starting or leash release position. At 17-2, the actuator is pressed and braking occurs. At 17-3, the actuator is pressed all the way down to stop the leash and a “click” is audible, indicating that the leash lock is engaged with the wheel. At 17-4, the actuator is released and is moved slightly back so that the lock is still engaged. The pin arms move up and stay locked upward. Another audible “click” indicator can be heard. At 17-5, the actuator is pressed (forward) again. Another audible “click” indicator can be heard. At 17-6, the actuator is released causing the pin arms to move back to a starting or leash release position. The lock disengages from the wheel. A final audible “click” indicator can be heard. Since the wheel drum is retractable, the leash can either extend further if pulled by an animal, or retract back into the housing and spool about the drum.

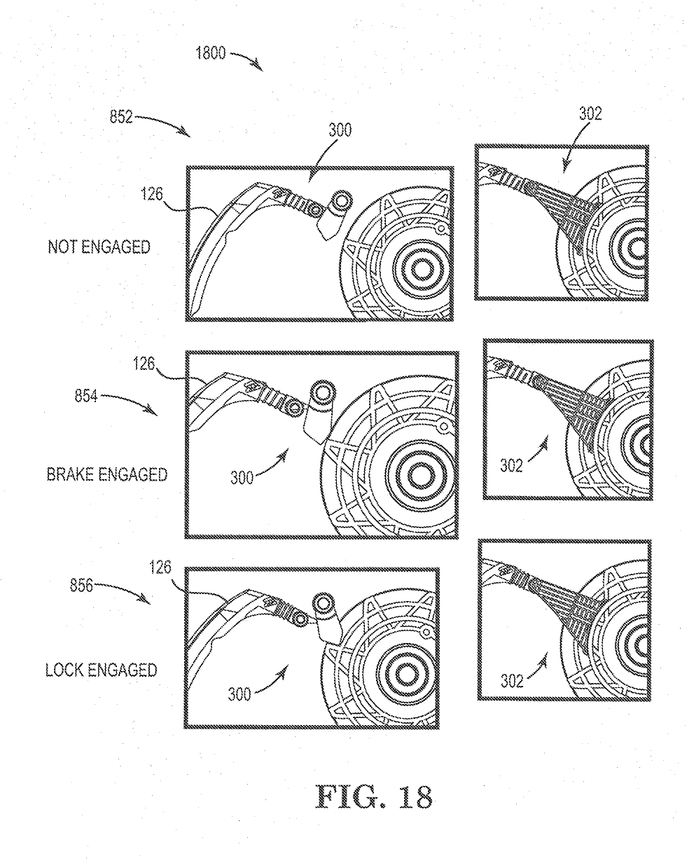

FIG. 18 illustrates one example of a position of the lock assembly 300 and the brake mechanism 302 during different modes of operation at 1800. At 852, neither the brake mechanism 302 nor the lock assembly 300 are engaged. At 854, the brake assembly 302 is illustrated in an engaged position. At 856, the brake assembly 302 is illustrated in an engaged position and the lock assembly 304 is illustrated in a locked position.

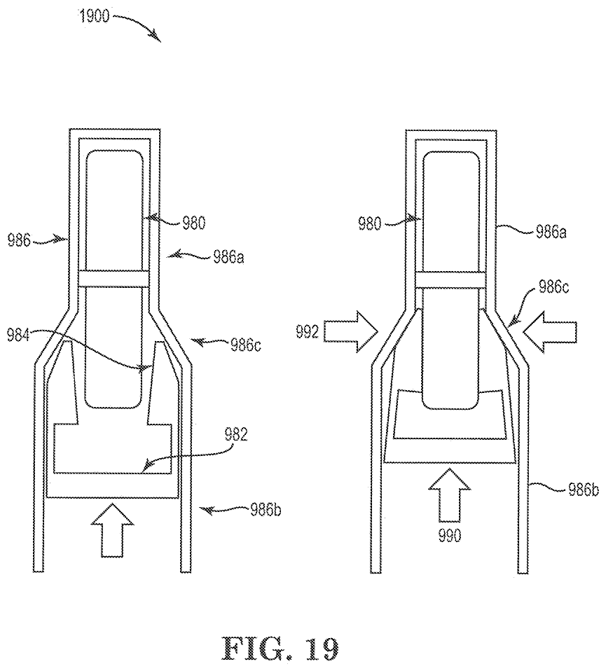

FIG. 19 illustrates another example of operation of a palm operable leash assembly at 1900 including a side braking mechanism or mode of operation. Breaking of the leash wheel or spool 980 is accomplish by applying a sideways pressure on the leash wheel 980. The brake assembly 1900 includes a bracket 982 that includes brake pads 984. In one example, the bracket 982 is generally U-shaped, with the brake pads 984 positioned at the ends of the bracket 982 and facing each side of the leash spool. Housing 986 has a unique shape that is narrowly positioned about wheel 980 (at 986a), and wider outside of wheel 980. (at 986b). As such, there is a narrowing transition of housing 986 between 986b and 986a, indicated as 986c. During a braking operation, upon activation of the actuator the brake pads 984 are pushed inward toward the spool 980. As the bracket is pushed forward indicated at 990, the shape of the housing 986 at 986c causes the bracket to flex inward (indicated at 992), forcing the pads 984 to engage and slow the rotation of the spool 980.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. For example, a leash may be stored in the housing or something other than a spool and still have a palm operable actuator. Therefore, it is intended that this invention be limited only by the claims and the equivalents thereof.

1-29. (canceled)

30. A leash assembly comprising:
a housing including a housing body and a handle having a palm region;
a leash spooled within the housing body; and
an actuator located in the palm region of the handle, where activation of the actuator within the palm region operates the leash to control an amount of leash extended from the housing.

31. The leash of claim 30, the actuator comprising a compressible button.

32. The leash of claim 31, where the compressible button extends through an opening in the housing.

33. The leash of claim of claim 31, where the leash handle includes an exterior surface and an interior surface, including a central opening for extending a user hand therethrough that defines the interior surface.

34. The leash of claim 33, where the compressible button is positioned at the exterior surface of the handle in the palm region.

35. The leash of claim 34, where the compressible button extends longitudinally along a length of the palm region.

36. The leash of claim 31, where activation of the compressible button causes a braking mode of operation of the leash assembly.

37. The leash of claim 36, where the compressible button has a compressible length, and where an amount of braking of the leash is proportional to an amount the compressible button is compressed along the compressible length.

38. A retractable leash assembly comprising:
a housing including a housing body and a handle;
a wheel drum located within the housing body, where a leash spools within the housing body about the wheel drum, the handle operably connected to the wheel drum; and
where the handle includes a palm region located about an outer edge of the handle, and where activation of the handle within the palm region aids in controlling the amount of leash extended from the housing.

39. The leash of claim 38, the handle including an actuator button located in the palm region, operably connected to the wheel drum.

40. The leash of claim 38, where the button extends through the housing, on an exterior surface of the palm region.

41. The leash of claim 38, where the button extends through the housing on an interior surface of the palm region.

42. The leash of claim 38, where the button comprises a compressible area within the palm region.

43. The leash of claim 38, comprising a locking assembly operably coupled between the handle and the wheel drum.

44. The leash of claim 38, comprising a brake mechanism operably coupled between the handle and the wheel drum.

45. The leash of claim 38, the wheel drum comprising a spool region that spools a length of leash during operation of the leash.

46. The leash of claim 45, the wheel drum comprising a stop region for stopping the leash at a desired length during operation of the leash.

47. The leash of claim 45, the wheel drum comprising a breaking surface to aid in controllably breaking a rotation of the wheel drum during release of the leash.

48. The leash of claim 45, the wheel drum comprising a spool region, a stop region, and a braking region.

49. The leash of claim 48, the leash comprising a gear assembly operably coupled between the actuator and the wheel drum.

50. The leash of claim 49, where the gear assembly aids in controllably moving the leash between one or more of a release mode, a braking mode, a stop mode, and a retractable mode of operation.

51. The retractable leash of claim 38, where activation of the leash handle causes a braking operation of the leash.

52. The retractable leash of claim 39, where activation of the leash handle includes squeezing the leash handle, and the amount of braking of the leash is proportional to the amount the handle is squeezed.

53. The retractable leash of claim 38, where activation of the leash handle causes locking and unlocking of the leash.

54. A retractable leash system comprising:
a leash body and a handle, the handle having a palm region;
a wheel drum located within the leash body, including where the leash spools within the leash body about the wheel drum, the handle operably connected to the wheel drum;
a leash actuator located within the palm region; and
a gear assembly operably positioned between the leash actuator and the wheel drum, where activation of the leash actuator operates to move the leash between one or more modes of operation via the gear assembly.

55. The leash of claim 54, where the leash modes of operation include at least two of the following modes: leash release, leash brake, leash stop, and leash retract.

56. The leash of claim 54, where the leash actuator comprises a compressible button located in the palm region.

57. The leash of claim 54, the leash further comprising an additional leash button operably positioned outside of the palm region.

58. The leash of claim 57, where the additional leash button is a thumb button extending from a top of the leash body.

59. A method of operating the retractable leash system of claim 54.
